(19) United States
(12) Patent Application Publication
(10) Pub. No.: US 2006/0103793 A1
(43) Pub. Date: May 18, 2006

(54) Normally white supper twisted nematic liquid crystal display device

(75) Inventors: Frans Leenhouts, Heerlen (NL); Hendrik Klaas Louwsma, Heerlen (NL); Marcel Herman Jozef Maria Hannemann, Heerlen (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.C.

(21) Appl. No.: 10/540,104

(22) PCT Filed: Dec. 10, 2003
(86) PCT No.: PCT/IB03/05959

§ 371 Date: Jun. 20, 2005

(30) Foreign Application Priority Data
Dec. 19, 2002 (EP) 02080370.6

(51) Int. Cl. G02F 1/1335

(52) U.S. Cl. 349/114

(57) ABSTRACT

This invention relates to a normally white super-twist nematic liquid crystal display device for multiplex operation, comprising a liquid crystal cell essentially comprising a liquid crystal layer (2), being sandwiched between a front and a rear substrate (3, 4), an at least partly reflective film (5, 13, 14, 15), arranged in proximity to said rear substrate (4), and a front optical stack, arranged on a viewer's side of the front substrate, the stack comprising one or more optical films, wherein the front optical stack consists solely of a polarizer (7) and an optional light scattering film (6).

This invention relates to a normally white super-twist nematic liquid crystal display device for multiplex operation.

In recent years, the use of twisted nematic liquid crystal displays, such as super twisted nematic liquid crystal displays (STN LCD) has increased within various fields, for example for mobile applications. Super twisted nematic liquid crystal displays are available in various configurations, and examples of such configurations are optical mode interference (OMI) displays and film compensated super twisted nematic (FSTN) displays. Both configurations are comparatively cost-efficient and may be driven by multiplexed addressing techniques. However, both of the above-mentioned configurations have drawbacks.

Regarding OMI displays, an example of such a display is disclosed in the patent document U.S. Pat. No. 5,557,434. This document discloses a display comprising a plurality of carefully designed compensation films, and hence this construction is comparatively expensive to produce. Moreover, the large number of layers tend to increase the total thickness of the display, which is undesirable, for example when it comes to mobile applications.

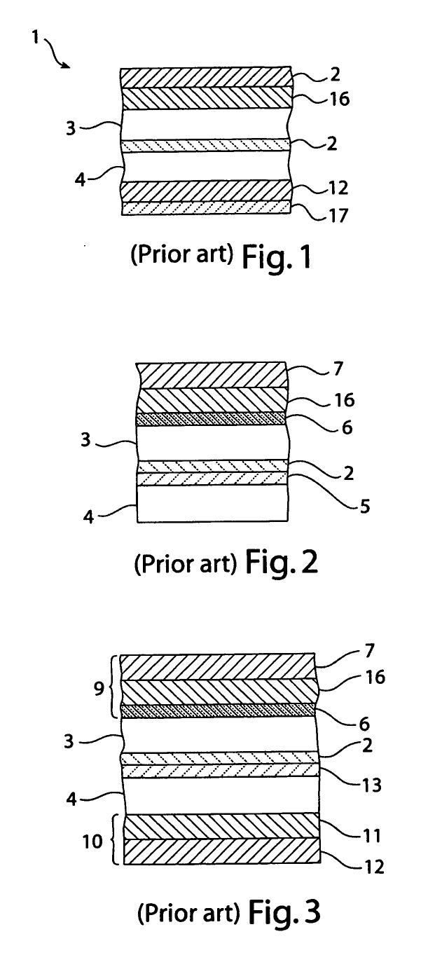

Regarding FSTN displays, a schematic drawing of an example of such a display is disclosed in FIG. 1. This configuration essentially comprises a liquid crystal layer, being sandwiched between a front and a back substrate. On a front side thereof, a front polarizer and a compensation film is arranged, whereby the film is sandwiched between the front substrate and the front polarizer. On a backside thereof, a back polarizer and a transflector is arranged, whereby the back polarizer is sandwiched between the back substrate and the transflector. However, this construction has a couple of disadvantages in the reflective mode. First, the display experiences parallax, which results from the position of the transflector, i.e. behind the back polarizer. Secondly, the display suffers from relatively low brightness in the reflective mode, resulting from absorption of light by the polarizers, due to the fact that light in this construction must pass a polarizer four times before reaching an observer of the display, and every passage through a polarizer results in a loss of brightness due to absorption.

In order to increase the brightness in the reflective mode, super twisted nematic displays utilizing a so-called internal, in-cell reflector (transflector) have been developed. Examples of such displays are disclosed in FIG. 2 (internal reflector) and FIG. 3 (internal transflector). In both embodiments, the reflector/transflector is positioned in the liquid crystal cell, i.e. between the substrates, and hence the number of passages through a polarizer in the reflective mode will be reduced.

Super twisted nematic liquid crystal displays making use of an internal transflector or reflector may essentially be of one of two types, normally white (NW) or normally black (NB). Both types make use of a front optical stack, positioned on an observer side of the liquid crystal cell, the front optical stack comprising a front polarizer and one or two compensation films and usually a light scattering film located between the front substrate and the compensation film or films. If an internal transflector is used (see FIG. 3), the display further comprises a rear optical stack, comprising a polarizer and one or two compensation films, the polarizer and the compensation films together constituting a so-called circular polarizer. For both NW and NB displays, the retardation and the twist angle of the twisted nematic liquid crystal layer commonly used in STN LCDs with internal reflector or transflector are typically 760-860 mn and 240°-270°, respectively.

However, as indicated above there is still a need for displays that can be manufactured at a lower cost, and that also have a reduced thickness, as compared to the prior art displays described above. Hence, an object of this invention is to achieve a reflective or transflective STN display, which can be realized in a cost-efficient manner. Yet another object of this invention is to achieve a reflective or transflective STN display having a reduced thickness, and a further object of this invention is to achieve a reflective or transflective STN display having a higher off-state brightness in a reflective mode, as compared to a reflective FSTN LCD.

The above and other objects are at least partly achieved in accordance with the invention by a normally white super-twist nematic liquid crystal display device for multiplex operation as described by way of introduction, which further comprises a liquid crystal cell essentially comprising a liquid crystal layer, being sandwiched between a front and a rear substrate, an at least partly reflective film, arranged in proximity to said rear substrate, and a front optical stack, arranged on a viewer's side of the front substrate, the stack comprising one or more optical films, the front optical stack consisting essentially of a polarizer and an optional light scattering film.

By positioning the at least partly reflective film, arranged in proximity to said rear substrate, and using a suitably designed liquid crystal layer, the front optical stack may essentially consist of only a polarizer and an optional light scattering film, i.e. no compensation films are needed in the front optical stack. Hence, the inventive display can be manufactured at a lower cost, and also be made thinner than corresponding prior art displays.

According to the invention, the retardation of said liquid crystal layer is suitably in the range of 500-750 nm.

According to one embodiment of the invention, said at least partly reflective film is a reflective film, enabling reflective operation of the display device.

According to a second embodiment, said at least partly reflective film is a transflective film, enabling transflective operation of the display device. Suitably the transflective display comprises a back optical stack, arranged on a back side of the liquid crystal layer, the stack comprising one or more optical films. The rear optical stack suitably comprises a rear polarizer and a compensation film, being arranged between the rear polarizer and the liquid crystal cell.

The invention may utilize an at least partly reflective film being arranged as an in-cell internal reflector between said front and rear substrate. Alternatively, said at least partly reflective film is arranged in said rear optical stack, essentially adjacent to said rear substrate.

The invention will hereinafter be described by means of presently preferred embodiments thereof, with reference to the accompanying drawings.

FIG. 1 shows a schematic cross-section of a film super twisted nematic liquid crystal display according to the prior art,

FIG. 2 shows a schematic cross-section of a reflective super twisted nematic liquid crystal display with an in-cell reflector according to the prior art,

FIG. 3 shows a schematic cross-section of a transflective super twisted nematic liquid crystal display with an in-cell transflector according to the prior art,

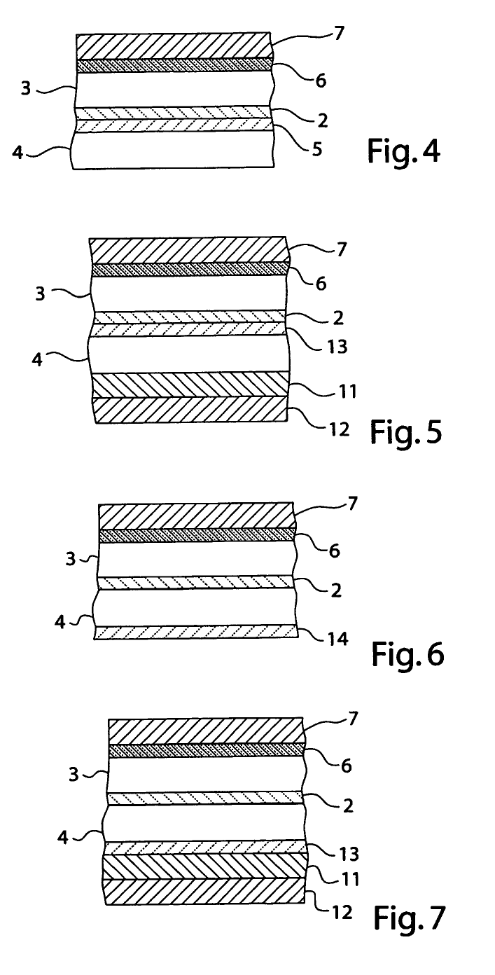

FIG. 4 shows a schematic cross-section of a reflective super twisted nematic liquid crystal display with an in-cell reflector according to the invention,

FIG. 5 shows a schematic cross-section of a transfiective super twisted nematic liquid crystal display with an in-cell transflector according to the invention,

FIG. 6 shows a schematic cross-section of a reflective super twisted nematic liquid crystal display with an external reflector according to the invention,

FIG. 7 shows a schematic cross-section of a transflective super twisted nematic liquid crystal display with an external transflector according to the invention,

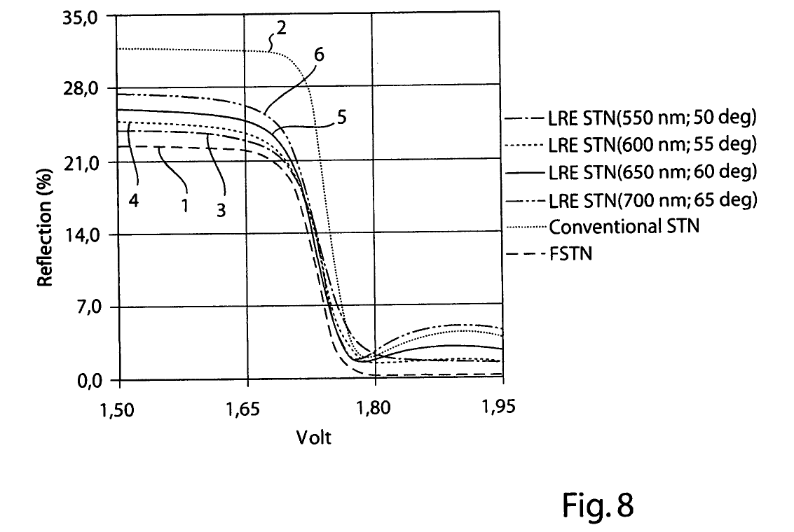

FIG. 8 shows a reflection-voltage graph for six reflective display configurations,

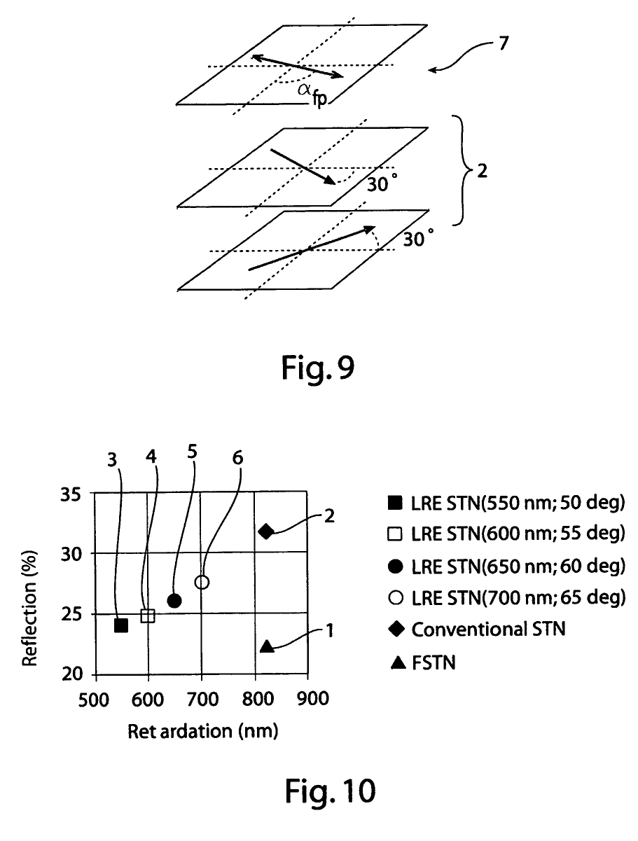

FIG. 9 is a schematic drawing showing the orientation of a front polarizer absorption axis in relation to directions of rubbing for the liquid crystal cell,

FIG. 10 is a plot showing the off-state reflection for the six reflective display configurations of FIG. 8,

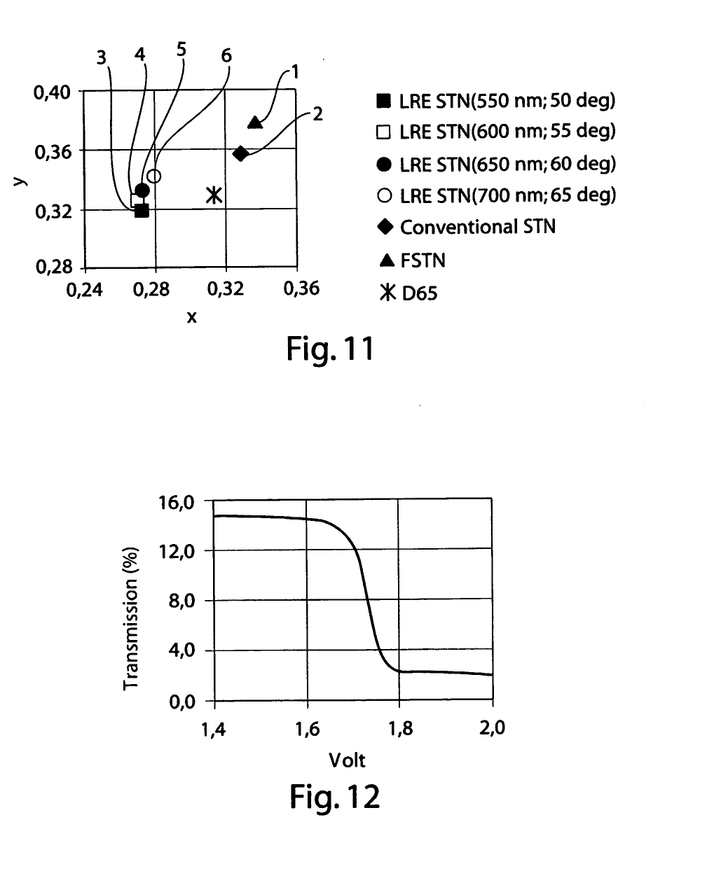

FIG. 11 is a plot showing the off-state color coordinates for the six reflective display configurations of FIG. 8,

FIG. 12 shows a transmission-voltage graph for a transflective display configuration according to the invention,

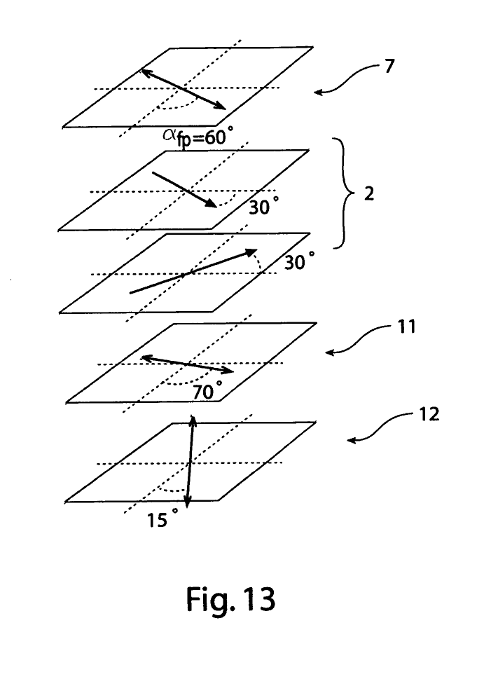

FIG. 13 is a schematic drawing showing the orientation of the front and rear polarizer absorption axes in relation to directions of rubbing for the liquid crystal cell, and the slow axes of a rear compensation layer for a transflective display according to the invention.

This invention is based on the realization that a normally white super twisted nematic liquid crystal display (NW STN LCD) having an in-cell reflector/transflector (or a near-cell reflector/transflector as will be described below) and fulfilling the objects of the invention stated above, may be obtained by using a front optical stack consisting solely of a polarizer and an optional light scattering film. Hence, compensation films need not be included in the front optical stack, which is an improvement as compared to the prior art. Consequently, the stack may be made thinner, and the manufacturing process may be simplified.

A first embodiment of this invention is disclosed in FIG. 4. This device 1 comprises a super twisted nematic liquid crystal layer 2 being arranged between a front and a back substrate 3, 4. The liquid crystal layer is arranged to be controlled by means of an electrode structure (not shown) on said front and back substrate. Furthermore, the device comprises an in-cell reflector 5, being arranged between the liquid crystal layer 2 and the back substrate 4. Together, the front and back substrate 3,4, the liquid crystal layer 2 and the in-cell reflector 5 form a liquid crystal cell 8. On an observer's side of the liquid crystal cell 8, a front optical stack 9 is arranged, comprising a front polarizer 7 and an optional light scattering film 6. It shall be noted that in this context the term light scattering film as used in this application shall be construed as a member scattering light passing through it, and said member may hence comprise a film formed by one or more individually formed layers. The light scattering film 6 is sandwiched between the front polarizer 7 and the front substrate 3. The above-mentioned liquid crystal layer 2 has a twist angle of about 195-270°, preferably about 240-270°, in order to be suitable for multiplex operation. Furthermore, the liquid crystal layer 2 is chosen to have a retardation of about 500-750 nm. It shall be noted that this retardation interval is lower than for prior art FSTN and conventional STN LCDs, which have a retardation within the interval 760-860 nm. Hence, the inventive display may be referred to as a low retardation LCD. By using a low retardation liquid crystal layer together with the proposed front optical stack, the use of compensation films may be avoided. Thereby, the manufacturing cost of the display can be reduced, and at the same time, the thickness of the display can be reduced. In the above-described embodiment, an in-cell reflector 5 is used. However, the invention may also be implemented in liquid crystal displays utilizing an external reflector, such as a near-cell reflector for example being fastened onto the external side of the rear substrate 4. A second embodiment of this invention, including an external reflector, is disclosed in FIG. 6. This embodiment is similar to the one disclosed in FIG. 4, with the exception that the in-cell reflector 5 of FIG. 4 is excluded, and instead an external reflector 14 is arranged, the reflector being formed on an external side of the rear substrate 4.

The present invention may also be realized as a transflective display. A third embodiment of the invention, illustrating this, is shown in FIG. 5. This device 1 comprises a super twisted nematic liquid crystal layer 2 being arranged between a front and a back substrate 3, 4. The liquid crystal layer is arranged to be controlled by means of an electrode structure (not shown) on said front and back substrate. Furthermore, the device comprises an in-cell transflector 13, being arranged between the liquid crystal layer 2 and the back substrate 4. Together, the front and back substrate 3, 4, the liquid crystal layer 2 and the in-cell transflector 13 form a liquid crystal cell 8. On an observer's side of the liquid crystal cell 8, a front optical stack 9 is arranged, comprising a front polarizer 7 and an optional light scattering film 6. It is noted in this context that the term light scattering film as used in this application shall be construed as a member scattering light passing through it, and said members may hence comprise a film formed by one or more individually formed layers. The light scattering film 6 is sandwiched between the front polarizer 7 and the front substrate 3. Moreover, on a rear side of the liquid crystal cell 8, a rear optical stack 8 is arranged, comprising a rear polarizer 12 and a compensation film 11, sandwiched between the rear polarizer 12 and the back substrate. Also in this case, the above-mentioned liquid crystal layer 2 has a twist angle of about 195-270°, preferably about 240-270°, in order to be suitable for multiplex operation. Furthermore, the liquid crystal layer 2 is chosen to have a retardation of about 500-750 nm. It shall be noted that this retardation interval is lower than for prior art FSTN and conventional STN LCDs, which have a retardation within the range of 760-860 nm. Hence, the inventive display may be referred to as a low retardation LCD. By using a low retardation liquid crystal layer together with the proposed front optical stack, the use of compensation films may be avoided. Thereby, the manufacturing cost of the display can be reduced, and at the same time, the thickness of the display can also be reduced. In the same way as mentioned above, the invention may also be implemented in liquid crystal displays utilizing an external transflector, such as a near-cell transflector for example being fastened onto the external side of the rear substrate 4. A fourth embodiment of this invention, including an external transflector, is disclosed in FIG. 7. This embodiment is similar to the one disclosed in FIG. 5, with the exception that the in-cell transflector 13 of FIG. 5 is excluded, and instead an external transflector 15 is arranged, the transflector being sandwiched between the rear substrate 4 and the compensation film 11. In both cases, the external reflector/transflector may for example be attached to the rear substrate 4 by means of gluing. In both transflective embodiments disclosed in FIGS. 5 and 7, a compensation film 11 is included in the rear optical stack 10. The transmission-voltage curve for a transflective LRE STN LCD, having a retardation of 650 nm and a front polarizer angle α_{fp}=60° (see FIG. 9), is disclosed in FIG. 12 while the optical configuration of this display is disclosed in FIG. 13. In this case, the compensation film 11 is constituted by a 140 nm quarter wave plate.

The effect of the low retardation super twisted nematic liquid crystal displays disclosed above will hereinafter be described in closer detail. FIG. 8 shows the reflection-voltage curve for six different super twisted nematic displays:
1) a standard FSTN display with a retardation of about 820 nm.
2) a 240° twist conventional NW STN display with an internal reflector and a retardation of about 820 nm.
3) a LRE STN according to the invention with an internal reflector (see FIG. 4) and a retardation of 550 nm and a front polarizer angle α_{fp}=50° (will be closer described below).
4) a LRE STN according to the invention with an internal reflector (see FIG. 4) and a retardation of 600 nm and a front polarizer angle α_{fp}=55° (will be closer described below).
5) a LRE STN according to the invention with an internal reflector (see FIG. 4) and a retardation of 650 nm and a front polarizer angle α_{fp}=60° (will be closer described below).
6) a LRE STN according to the invention with an internal reflector (see FIG. 4) and a retardation of 700 nm and a front polarizer angle α_{fp}=65° (will be closer described below).

In all cases, the curves of FIG. 8 were calculated assuming that the reflector is ideal, i.e. has a reflection of 100%. As is indicated by FIG. 8, the inventive LRE STN displays (3-6) have lower retardation values than the prior art displays (1-2). Moreover, it is seen from FIG. 8 that the steepness of the reflection-voltage curves does not differ much between the different displays. This implicates that the multiplex capability of the LRE STN displays (3-6) is comparable to that of the standard and conventional displays (1-2). The front polarizer angle α_{fp} defines the orientation of the absorption axis of the front polarizer 7, as indicated by FIG. 9. FIG. 9 also discloses the rubbing directions affecting the alignment of the liquid crystal layer 2 in a manner known per se.

FIG. 10 discloses the off-state reflections of the above-defined display configurations (1-6). As is seen from FIG. 10, the off-state reflection of the LRE STN LCDs (3-6) according to the invention is higher than the corresponding off-state reflection of the FSTN LCD (1), but lower than the off-state reflection of the conventional LCD (2) with an internal reflector (or transflector) and two compensation films. Hence, the Off-state reflection of the inventive LRE STN LCDs are at a satisfactory level.

FIG. 11 discloses the off-state color coordinates in a reflective mode for the above-defined display configurations (1-6). As is seen from FIG. 11, the off-state color neutrality of the LRE STN LCDs (3-6) is somewhat bluish. However, the color neutrality of the inventive LRE STN LCDs (3-6) is better than the color neutrality of the prior art displays (1-2).

1. A normally white super-twist nematic liquid crystal display device for multiplex operation, comprising:
a liquid crystal cell essentially comprising a liquid crystal layer, being sandwiched between a front and a rear substrate,
an at least partly reflective film, arranged in proximity to said rear substrate, and
a front optical stack, arranged on a viewer's side of the front substrate, the stack comprising one or more optical films,
wherein the front optical stack consists essentially of a polarizer and an optional light scattering film.

2. A display device as claimed in claim 1, wherein the retardation of said liquid crystal layer is in the range of 500-750 nm.

3. A display device as claimed in claim 1, wherein said at least partly reflective film is a reflective film enabling reflective operation of the display device.

4. A display device as claimed in claim 1, wherein said at least partly reflective film is a transflective film enabling transflective operation of the display device.

5. A display device as claimed in claim 4, further comprising a rear optical stack, arranged on a back side of the liquid crystal layer, the stack comprising one or more optical films.

6. A display device as claimed in claim 5, wherein said rear optical stack comprises a rear polarizer and a compensation film, being arranged between the rear polarizer and the liquid crystal cell.

7. A display device as claimed in claim 1, wherein said at least partly reflective film is arranged as an in-cell internal reflector between said front and rear substrate.

8. A display device as claimed in claim 1, wherein said at least partly reflective film is arranged in said rear optical stack, essentially adjacent to said rear substrate.
